(19) United States
(12) Patent Application Publication
(10) Pub. No.: US 2013/0346554 A1
(43) Pub. Date: Dec. 26, 2013

(54) TRANSMISSION PROCESSING METHOD AND APPARATUS, ELECTRONIC DEVICE

(71) Applicants: Haoyu Ren, Beijing (CN); Tianshu Wang, Beijing (CN); Junfeng Liu, Beijing (CN)

(72) Inventors: Haoyu Ren, Beijing (CN); Tianshu Wang, Beijing (CN); Junfeng Liu, Beijing (CN)

(21) Appl. No.: 14/003,351

(22) PCT Filed: Mar. 15, 2012
(86) PCT No.: PCT/CN12/72343

§ 371 Date: Sep. 5, 2013

(30) Foreign Application Priority Data
Mar. 15, 2011 (CN) 201110061386.3
May 16, 2011 (CN) 201110125806.X

(51) Int. Cl. H04L 29/08

(52) U.S. Cl. CPC H04L 67/06
USPC 709/217

(57) ABSTRACT

The present invention discloses transmission processing methods, apparatuses and electronic devices. The transmission processing method includes: detecting a first operation applied to an object in a source device; determining whether the first operation is a first predetermined operation, and obtaining a first determination result; and transmitting a notification message to a first target device connected with the source device when the first determination result indicates that the first operation is the first predetermined operation, such that the first target device can obtain an object data of the object from the source device based on the notification message. Embodiments of the present invention provide a simple approach for interaction between electronic devices and improve efficiency of user operations.

### TECHNICAL FIELD

Embodiments of the present invention relate to electronic technology, and more particularly, to transmission processing methods and apparatuses, and electronic devices.

### BACKGROUND

With today's rapid development of science and technology, users have a growing number of electronic devices. For example, generally a user may have various electronic devices such as a cell phone, PAD, a handheld game machine and the like.

In many cases, communications between various electronic devices are desired. For example, a user may want to transfer resources acquired from Internet by a cell phone to a tablet computer for watching, or to use a tablet computer to remotely control a digital whiteboard. Thus, there is an inevitable trend to explore schemes for interaction between electronic devices.

During implementation of embodiments of the present invention, the inventors found at least the following drawbacks in the prior art: currently commands for data processing and the like within a single electronic device have been well defined; however, interactions between electronic devices are not easy to implement, for example, many user operations are required, and thus the interaction is very inconvenient and inefficient in operation.

### SUMMARY

Embodiments of the present invention are intended to provide transmission processing methods and apparatuses, and electronic devices, which can provide a user with a simple approach for interaction between electronic devices and improve efficiency of user operations.

In order to achieve the above object, according to an embodiment of the present invention, a transmission processing method is provided. The method includes: detecting a first operation applied to an object in a source device; determining whether the first operation is a first predetermined operation, and obtaining a first determination result; and transmitting a notification message to a first target device connected with the source device when the first determination result indicates that the first operation is the first predetermined operation, such that the first target device can obtain object data of the object from the source device based on the notification message.

In the above transmission processing method, the notification message contains notification information which is different from the object data of the object and indicates to the first target device that the source device has an object to be transmitted to the first target device. The above transmission processing method further includes: determining whether a first response message is received, and obtaining a second determination result, the first response message being returned by the first target device after receiving the notification message; and transmitting the object data of the object to the first target device via a communication channel to the first target device when the second determination result indicates that the first response message is received.

In the above transmission processing method, the first response message is generated and returned to the source device when the first target device detects a second predetermined operation after receiving the notification message.

In the above transmission processing method, after receiving the notification message, the first target device directly detects whether the second predetermined operation occurs without displaying the notification information.

In the above transmission processing method, the notification information includes object information of the object.

In the above transmission processing method, the object information includes a storage location where the object is stored, such that the first target device can obtain the object by downloading it from the source device based on the storage location.

In the above transmission processing method, the object information includes a storage location where the object is stored and object description information of the object, such that the first target device can determine whether to obtain the object or not based on the object description information and obtain the object by downloading it from the source device based on the storage location when it determines to obtain the object.

In the above transmission processing method, the object information includes object description information of the object. The above transmission processing method further includes: determining whether a second response message is received, and obtaining a third determination result, the second response message is being returned by the first target device when the first target device determines to obtain the object based on the object description information after receiving the notification message; and transmitting the object data to the first target device via a communication channel to the first target device when the third determination result indicates that the second response message is received.

In the above transmission processing method, when the first operation applied to each of a plurality of objects by the source device is the first predetermined operation, the step of transmitting a notification message to a first target device connected with the source device includes: transmitting respective notification messages sequentially in accordance with the order in which the first operation is applied to the plurality of objects, such that the first target device can obtain the plurality of objects from the source device based on all the notification messages it receives currently.

The above transmission processing method further includes: determining whether a first response message is received, and obtaining a fourth determination result, the first response message being returned by the first target device for a first notification message after receiving the notification messages; and transmitting object data of a first object corresponding to the first notification message to the first target device via a communication channel to the first target device when the fourth determination result indicates that the first response message is received.

In the above transmission processing method, each of the notification messages includes storage location information indicating a location where the object corresponding to that notification message is stored, such that the first target device can obtain the object data of the first object corresponding to the first notification message by downloading it from the source device based on the storage location information corresponding to the first notification message.

In order to achieve the above object, according to an embodiment of the present invention, a transmission processing apparatus is provided. The apparatus includes: a detection module configured to detect a first operation applied to an object in a source device; a first determination module configured to determine whether the first operation is a first predetermined operation, and obtain a first determination result; and a message transmission module configured to transmit a notification message to a first target device connected with the source device when the first determination result indicates that the first operation is the first predetermined operation, such that the first target device can obtain object data of the object from the source device based on the notification message.

In the above transmission processing apparatus, the notification message contains notification information which is different from the object data of the object and indicates to the first target device that the source device has an object to be transmitted to the first target device. The transmission processing apparatus further includes: a second determination module configured to determine whether a first response message is received, and obtain a second determination result, the first response message being returned by the first target device after receiving the notification message; and a first transmission module configured to transmit the object data of the object to the first target device via a communication channel to the first target device when the second determination result indicates that the first response message is received.

In the above transmission processing apparatus, the first response message is generated and returned to the source device when the first target device detects a second predetermined operation after receiving the notification message.

In the above transmission processing apparatus, after receiving the notification message, the first target device directly detects whether the second predetermined operation occurs without displaying the notification information.

In the above transmission processing apparatus, the notification information includes object information of the object.

In the above transmission processing apparatus, the object information includes a storage location where the object is stored, such that the first target device can obtain the object by downloading it from the source device based on the storage location.

In the above transmission processing apparatus, the object information includes a storage location where the object is stored and object description information of the object, such that the first target device can determine whether to obtain the object or not based on the object description information, and obtain the object by downloading it from the source device based on the storage location when it determines to obtain the object.

In the above transmission processing apparatus, the object information includes object description information of the object. The above transmission processing apparatus further includes: a third determination module configured to determine whether a second response message is received, and obtain a third determination result, the second response message being returned by the first target device when the first target device determines to obtain the object based on the object description information after receiving the notification message; and a second transmission module configured to transmit the object data to the first target device via a communication channel to the first target device when the third determination result indicates that the second response message is received.

In the above transmission processing apparatus, when the first operation applied to each of a plurality of objects by the source device is the first predetermined operation, the message transmission module is configured to transmit respective notification messages sequentially in accordance with the order in which the first operation is applied to the plurality of objects, such that the first target device can obtain the plurality of objects from the source device based on all the notification messages it receives currently.

The above transmission processing apparatus further includes: a fourth determination module configured to determine whether a first response message is received, and obtain a fourth determination result, the first response message being returned by the first target device for a first notification message after receiving the notification messages; and a third transmission module configured to transmit object data of a first object corresponding to the first notification message to the first target device via a communication channel to the first target device when the fourth determination result indicates that the first response message is received.

In the above transmission processing apparatus, each of the notification messages includes storage location information indicating a location where the object corresponding to that notification message is stored, such that the first target device can obtain the object data of the first object corresponding to the first notification message by downloading it from the source device based on the storage location information corresponding to the first notification message.

In order to achieve the above object, according to an embodiment of the present invention, an electronic device is provided. The electronic device includes: a storage module configured to store an object; an input module configured to receive an input operation from a user; a communication module configured to communicate with a further electronic device; a detection module configured to detect a first operation applied by the user to an object from the object stored in the storage module via the input module; a first determination module configured to determine whether the first operation is a first predetermined operation, and obtain a first determination result; and a message transmission module configured to transmit a notification message to a first target device via the communication module when the first determination result indicates that the first operation is the first predetermined operation, such that the first target device can obtain object data of the object from the source device based on the notification message.

Embodiments of the present invention have the following advantageous effects.

In the transmission processing method, apparatus and the electronic device according to the embodiments of the present invention, when a predetermined operation on an object is detected, a notification message is transmitted to the first target device connected to the source device, such that the first target device can obtain the object data of the object from the source device based on the notification message. In this way, the user needs to perform only one operation in order to transmit the object, and thus the user operation can be simplified and the user operation efficiency can be improved.

In the transmission processing method, apparatus and the electronic device according to the embodiments of the present invention, the storage location information can be carried by the notification message, and thus the target electronic device can directly download the object data of the object based on the storage location information. In this way, the downloading operation at the target electronic device can be fully automated without any intervention by the user. The user operation can be simplified.

In the method and transmission processing apparatus and the electronic device according to the embodiments of the present invention, the object information of the object can be carried by the notification message, and thus the target electronic device can determine whether the object data of the object is needed based on the object information of the object. In this way, unnecessary data transmission can be avoided, and the efficiency of data transmission can be improved.

According to a further embodiment of the present invention, a transmission processing method is provided. The method includes: obtaining, by a target device, description data of an object stored in a source device different from the target device; detecting, by the target device, a first operation applied to the description data; determining, by the target device, whether the first operation is a first predetermined operation, and obtaining a first determination result; deciding, by the target device, a sequence of instructions corresponding to the first predetermined operation when the first determination result indicates that the first operation is the first predetermined operation; and executing, by the target device, the sequence of instructions to process object data corresponding to the object.

In the above transmission processing method, the sequence of instructions includes a first sequence of instructions, and the step of the target device executing the sequence of instructions to process object data corresponding to the object includes: executing, by the target device, the first sequence of instructions to interact with the source device for obtaining the object data of the object.

In the above transmission processing method, the sequence of instructions includes a first sequence of instructions and a second sequence of instructions and the step of the target device executing the sequence of instructions to process object data corresponding to the object includes: executing, by the target device, the first sequence of instructions to obtain from the source device the object data corresponding to the object; and executing, by the target device, the second sequence of instructions to edit the object data.

In the above transmission processing method, the description data of the object is obtained by the target device from the source device after receiving a notification message or from the notification message directly, the notification message being transmitted by the source device to the target device when it detects that a second operation applied to the object is a second predetermined operation such that the target device can obtain object data of the object from the source device based on the notification message.

In the above transmission processing method, the notification message contains notification information which is different from the object data of the object and indicates to the target device that the source device has the object available to be transmitted to the target device.

In the above transmission processing method, the step of the target device executing the first sequence of instructions to obtain from the source device the object data corresponding to the object includes: returning, by the target device, a first response message after receiving the notification message; and receiving, by the target device, the object data returned by the source device via a communication channel upon receiving the response message.

In the above transmission processing method, the notification message has recorded therein a storage location where the object is stored. The step of the target device executing the first sequence of instructions to obtain from the source device the object data corresponding to the object includes: obtaining, by the target device, the storage location from the received notification message; and obtaining, by the target device, the object data by downloading it from the source device based on the storage location.

In order to achieve the above object, according to an embodiment of the present invention, a transmission processing apparatus is provided. The apparatus includes: a description data obtaining module configured to obtain a description data of an object, stored in a source device different from a target device; a detection module configured to detect a first operation applied to the description data; a determination module configured to determine whether the first operation is a first predetermined operation, and obtain a first determination result; an instruction sequence decision module configured to decide a sequence of instructions corresponding to the first predetermined operation when the first determination result indicates that the first operation is the first predetermined operation; and an execution module configured to execute the sequence of instructions to process an object data corresponding to the object.

In the above transmission processing apparatus, the sequence of instructions includes a first sequence of instructions, and the execution module includes: a first execution unit configured to execute the first sequence of instructions to interact with the source device for obtaining the object data of the object.

In the above transmission processing apparatus, the sequence of instructions includes a first sequence of instructions and a second sequence of instructions, and the execution module includes: a first execution unit configured to execute the first sequence of instructions to obtain from the source device the object data corresponding to the object; and a second execution unit configured to execute the second sequence of instructions to edit the object data.

In the above transmission processing apparatus, the description data of the object is obtained by the target device from the source device after receiving a notification message or directly from the notification message, the notification message being transmitted by the source device to the target device when it detects that a second operation applied to the object is a second predetermined operation such that the target device can obtain object data of the object from the source device based on the notification message.

In the above transmission processing apparatus, the notification message contains notification information which is different from the object data of the object and indicates to the target device that the source device has the object available to be transmitted to the target device.

In the above transmission processing apparatus, the first execution unit includes: a message responding unit configured to return a first response message after receiving the notification message; and a receiving unit configured to receive the object data returned by the source device via a communication channel upon receiving the response message.

In the above transmission processing apparatus, the notification message has recorded therein a storage location where the object is stored. The first execution unit includes: a storage location obtaining unit configured to obtain the storage location from the received notification message; and a downloading unit configured to obtain the object data by downloading it from the source device based on the storage location.

In order to achieve the above object, according to an embodiment of the present invention, an electronic device is provided. The electronic device includes: an input module configured to receive an input operation from a user; a communication module configured to communicate with a further electronic device; and a processor configured to: obtain description data of an object stored in a source device via the communication module; detect a first operation applied by the user to the description data via the input module; determine whether the first operation is a first predetermined operation, and obtain a first determination result; decide a sequence of instructions corresponding to the first predetermined operation when the first determination result indicates that the first operation is the first predetermined operation; and execute the sequence of instructions to process is object data corresponding to the object.

In the above electronic device, the processor includes: a description data obtaining module configured to obtain the description data; a detection module configured to detect the first operation applied to the description data; a determination module configured to determine whether the first operation is the first predetermined operation, and obtain the first determination result; an instruction sequence decision module configured to decide the sequence of instructions corresponding to the first predetermined operation when the first determination result indicates that the first operation is the first predetermined operation; and an execution module configured to execute the sequence of instructions to process object data corresponding to the object.

The embodiments of the present invention have the following advantageous effects.

In the transmission processing method, apparatus and the electronic device according to the embodiments of the present invention, the target device predefines a predetermined operation and sets a sequence of instructions corresponding to the predetermined operation. When it is detected that the operation applied by the user to the description data is the first predetermined operation, the target device is controlled to execute the sequence of instructions to process the object data corresponding to the object. The user can decide the subsequent processes depending on the description information. In this way, the flexibility of inter-device interaction can be improved.

In the transmission processing method, apparatus and the electronic device according to the embodiments of the present invention, when a predetermined operation on an object is detected at the source device, a notification message is transmitted to the target device, and thus the target device can obtain the object data of the object from the source device based on the notification message. In this way, the user needs to perform only one operation in order to transmit the object, and thus the user operation can be simplified and the user operation efficiency can be improved.

### BRIEF DESCRIPTION OF THE DRAWINGS

For clearer explanation of the solutions according to the embodiments of the present invention, the figures for illustrating the embodiments will be introduced briefly in the following. It is to be noted that the figures described below only illustrate some of the embodiments of the present invention and further figures can be derived by those skilled in the art from these figures.

FIG. 1 is a flowchart illustrating a transmission processing method according to an embodiment of the present invention;

FIG. 2 is a schematic block diagram of a transmission processing apparatus according to an embodiment of the present invention;

FIG. 3 is a schematic block diagram of an electronic device according to an embodiment of the present invention;

FIG. 4 is a flowchart illustrating a transmission processing method according to an embodiment of the present invention;

FIG. 5 is a flowchart illustrating a process of a source device transmitting a notification message according to an embodiment of the present invention;

FIG. 6 is a schematic block diagram of a transmission processing apparatus according to an embodiment of the present invention;

FIG. 7 is a schematic block diagram of an execution module according to an embodiment of the present invention;

FIG. 8 is a schematic block diagram of a first execution unit according to an embodiment of the present invention; and

FIG. 9 is a schematic block diagram of an electronic device according to an embodiment of the present invention.

### DETAILED DESCRIPTION OF THE EMBODIMENTS

In the transmission processing method, apparatus and the electronic device according to the embodiments of the present invention, when a predetermined operation on an object is detected, a notification message is transmitted to the first target device connected to the source device, such that the first target device can obtain the object data of the object from the source device based on the notification message. In this way, the user needs to perform only one operation for transmission of the object, and thus the user operation can be simplified and the user operation efficiency can be improved.

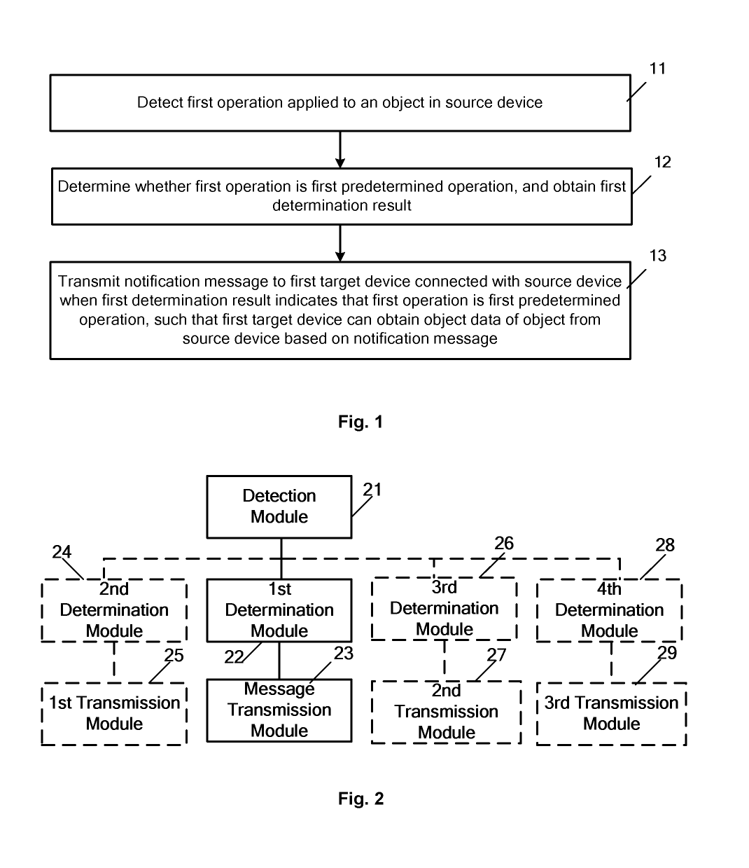

As shown in FIG. 1, the transmission processing method according to an embodiment of the present invention includes the following steps.

At step 11, a first operation applied to an object in a source device is detected.

At step 12, it is determined whether the first operation is a first predetermined operation, and a first determination result is obtained.

At step 13, when the first determination result indicates that the first operation is the first predetermined operation, a notification message is transmitted to a first target device connected with the source device such that the first target device can obtain object data of the object from the source device based on the notification message.

In an exemplary embodiment of the present invention, the object can be a folder, a file or an icon stored in the source device. That is, it can be any data carrier that can be selected by a user operation.

In an exemplary embodiment of the present invention, a predetermined operation is predefined, and an instruction corresponding to the predetermined operation is set to be an instruction for transmitting a notification message. When the predetermined operation applied by a user to an object is detected, the instruction corresponding to the predetermined operation can be executed to transmit the notification message to the first target device, such that the first target device can obtain the object data of the object from the source device based on the notification message. In this way, the user needs to perform only one operation for transmission of the object, and thus the user operation can be simplified and the user operation efficiency can be improved.

In an exemplary embodiment of the present invention, the predetermined operation may includes various operations. When the source device includes a touch screen, the first predetermined operation can be a touch operation that touches a display location of an operation object for a long duration, or a touch operation in which an area surrounded by a number of pointers is gradually reduced.

The present invention is not limited to these specific forms of the predetermined operation. The predetermined operation can also be represented by any of undefined operation gestures.

In an exemplary embodiment of the present invention, the notification message carries notification information that indicates to the first target device that the source device has an object available to be transmitted to the first target device. The notification information is different from the object data of the object. In other words, the notification information enables the first target device to obtain the object by taking further actions based on the notification information, but the first target device cannot obtain the object by parsing or reconstructing the notification information itself. The first target device can obtain the object only by further interacting with the source device.

In an exemplary embodiment of the present invention, a notification message is to be transmitted to the first target device connected with the source device. The first target device can be determined by using the following approaches.

1. Broadcast

The source device maintains a list recording all electronic devices that had ever been connected with the source device. When the first predetermined operation applied to the object in the source device is detected, a notification message is transmitted to each of the electronic devices in the list. In this case, only the device(s) currently connected with the source device can receive the notification message.

2. Detection

Upon detecting the first predetermined operation applied to the object in the source device, the source device searches for any electronic device connectable with the source device and determines all the electronic device(s) connectable with the source device as the first target device(s). Then, the source device establishes connection with the first target device(s), and broadcasts the notification message to the connected first target device(s).

3. User Selection

Upon detecting the first predetermined operation applied to the object in the source device, the source device searches for any electronic device connectable with the source device, and notifies the user of all the electronic device(s) connectable with the source device for selection by the user. Then, the source device determines the user-selected electronic device(s) as the first target device(s) and connects with the first target device(s) for broadcasting the notification message.

The specific approach for determining the target electronic device can be designed depending on specific requirements, of which further details will be omitted here.

The notification message can be implemented in various ways. In the following, various possible implementations of the notification message will be described in detail. The schemes for transmitting the object to the first object device will also be explained in detail.

<Implementation I>

In this implementation, the notification message is simply a prompt message indicating to the first target device that there is one or more objects obtainable by the first target device in the source device. However, the notification message itself does not contain any information about the object(s). In this case, according to an embodiment of the present invention, the transmission processing method further includes: determining whether a first response message is received, and obtaining a second determination result, the first response message being returned by the first target device after receiving the notification message; and transmitting the object data of the object to the first target device via a communication channel to the first target device when the second determination result indicates that the first response message is received.

In an exemplary embodiment of the present invention, the first response message is generated and returned to the source device when the first target device detects a second predetermined operation after receiving the notification message.

In this implementation, simple operations need to be performed on the source and target devices to achieve transmission of the object between the devices. The user operation can be simplified and the user operation efficiency can be improved.

An application example will be given below for illustrating the above implementation.

It is assumed that four users, A, B, C and D, are discussing a project in a conference room. The users each have a portable touch-controlled PAD, and these PADs have been connected with each other. Now, User A has a project schedule to be transmitted to User B, User C and User D for discussion.

In this case, User A selects the project schedule file and perform a grasp gesture on the file at its display location, i.e., User A's fingers first cover the file and then converge gradually.

When User A is performing the above gesture, the electronic device can detect the grasp gesture and determine that it is the predetermined operation. At this time, is the PAD of User A will transmit a notification message to the PAD of each of User B, User C and User D, notifying that there is an object to be transmitted in the PAD of User A. The notification message does not carry any specific information about the object.

However, since User B, User C and User D know what is to be transmitted by User A, they can perform a predetermined operation on their respective PADs. In this case, after receiving the notification message, the PAD of each of User B, User C and User D detects a second predetermined operation performed by that user, which indicates that the user wants to receive the object. Thus, the PAD of each of User B, User C and User D returns a response message to the PAD of User A. Upon receiving the response messages, the PAD of User A will transmit, via the communication channels to the PADs of User B, User C and User D, the object data of the object to the target devices

The techniques for establishing a communication channel and transmitting data via the established channel are well known to those skilled in the art and the details thereof will be omitted here.

In this case, since the information regarding the contents of the object is known to the users through interactions between them, there is no need to present any prompt on the electronic devices. Thus, after receiving the notification message, each of the first target devices (the PADs of User B, User C and User D) can directly detect whether the second predetermined operation occurs without displaying the notification information.

The above implementation is also applicable to a situation where several electronic devices are operated by a single user. In this situation, the user can transmit an object between the electronic devices by simply selecting the object on a first device with a predetermined gesture and performing another predetermined gesture on other electronic devices. In this way, the user operation can be simplified and the user operation efficiency can be improved.

<Implementation II>

In the above Implementation I, the notification message is simply a prompt message indicating to the first target device that there is one or more objects obtainable by the first target device in the source device. However, the notification message itself does not contain any information on the object(s). The Implementation I works well when the users are close to each other or the electronic devices are operated by the same user. However, when the electronic devices are operated by different users and the users are distant from each other, the respective users do not even know the information on the object. In this case, they may not respond and thus the object cannot be transmitted.

In order to solve this problem, in this implementation, the notification information includes object information of the object, such that the target electronic device supports transfer of the object between the electronic devices based on the object information.

In this implementation, the object information may include a storage location where the object is stored and/or object description information of the object. Three scenarios will be explained in the following.

Scenario 1

The object information includes a storage location where the object is stored, such that the first target device can obtain the object by downloading it from the source device based on the storage location.

Unlike the Implementation I, in this scenario, the object data of the object is not transmitted by the source device, but is downloaded by the first target device. Since the notification message carries the storage location of the object, the first target device can directly obtain the object by downloading it from the source device based on the storage location.

In Scenario I, the transmission of the object does not need to be prompted on the electronic device. After receiving the notification message, the first target device can download the object based on the storage location without displaying the notification message. The situation where the object cannot be transmitted will not occur.

Scenario 2

The object information includes a storage location where the object is stored and object description information of the object, such that the first target device can determine whether to obtain the object or not based on the object description information, and obtain the object by downloading it from the source device based on the storage location when it determines to obtain the object

Unlike the above Scenario 1, in this scenario, the object information includes not only the storage location of the object, but also the object description information (such as a file name or a brief introduction of the object). In this case, after receiving the notification message, the first target device can extract the object description information from the notification message and output the information (e.g., displaying on a display screen or notifying the user in an audible manner). Then, the first target device can determine whether to obtain the object or not in accordance with the user's selection.

The first target device can determine whether to obtain the object or not based on a predefined judgment criterion associated with the object description information. (For example, a criterion can be predefined such that it is determined to obtain the object only when its object description information contains a key word of “movie”.)

When it is determined to obtain the object, the object can be obtained by downloading it from the source device based on the storage location.

In this way, the efficiency in transmission of the object data can be improved since the target electronic device obtains the object desired by the user.

Scenario 3

The object information includes object description information of the object. In this case, since the storage location of the object is unknown to the target device, the source device needs to transmit the object. Accordingly, the transmission processing method includes: determining whether a second response message is received, and obtaining a third determination result, the second response message being returned by the first target device when the first target device determines to obtain the object based on the object description information after receiving the notification message; and transmitting the object data to the first target device via a communication channel to the first target device when the third determination result indicates that the second response message is received.

As in the above Scenario 2, it is possible to determine whether to obtain the object or not based on the object description information, of which the detailed description will be omitted here.

In an exemplary embodiment of the present invention, in many cases the source device needs to transmit a plurality of objects. When the first operation applied to each of the plurality of objects by the source device is the first predetermined operation, the step of transmitting a notification message to a first target device connected with the source device includes transmitting respective notification messages sequentially in accordance with the order in which the first operation is applied to the plurality of objects, such that the first target device can obtain the plurality of objects from the source device based on all the notification messages it receives currently.

An example will be given below.

It is assumed that, in the source device A, grasp operations are performed on objects X1, X2 and X3 at times t1, t2 and t3, respectively. In this case, the source device A will transmit the notification messages A1, A2 and A3 sequentially to the first target device B at the times t1, t2 and t3, respectively, in accordance with the order in which the grasp operation is applied to the objects.

It is further assumed that, at the time t2, the first target device B can obtain the object data corresponding to the objects X1 and X2 based on the received notification message A1 and A2. At the time t3, the first target device B can obtain the object data corresponding to the objects X1, X2 and X3 based on the received notification message A1, A2 and A3.

In an embodiment of the present invention, the object can be copied and transmitted to the target device, or can be directly cut and transmitted to the target device, in accordance with corresponding gestures. Here a gesture implies both an instruction for transmission and an instruction on whether to maintain the object locally. Further details for the gestures will be omitted here.

An abort mechanism can be provided in the method according to an embodiment of the present invention. When another predetermined operation is detected after the first predetermined operation, indicating that the source device decides to terminate the ongoing transmission, another notification message can be transmitted to the target electronic device to notify the termination of the transmission.

All the gestures (or predetermined operations) according to the embodiments of the present invention can be defined depending on the user's requirements, as long as they do not conflict with those defined operations.

FIG. 2 shows a transmission processing apparatus according to an embodiment of the present invention. The apparatus includes a detection module 21, a first determination module 22, and a message transmission module 23.

The detection module 21 detects a first operation applied to an object in a source device.

The first determination module 22 determines whether the first operation is a first predetermined operation, and obtains a first determination result.

The message transmission module 23 transmits a notification message to a first target device connected with the source device when the first determination result indicates that the first operation is the first predetermined operation, such that the first target device can obtain object data of the object from the source device based on the notification message.

In the transmission processing apparatus, the notification message contains notification information which is different from the object data of the object and indicates to the first target device that the source device has an object available to be transmitted to the first target device.

The transmission processing apparatus further includes a second determination module 24 and a first transmission module 25. The second determination module 24 is configured to determine whether a first response message is received, and obtain a second determination result. The first response message is returned by the first target device after receiving the notification message. The first transmission module 25 is configured to transmit the object data of the object to the first target device via a communication channel to the first target device when the second determination result indicates that the first response message is received.

In the transmission processing apparatus, the first response message is generated and returned to the source device when the first target device detects a second predetermined operation after receiving the notification message.

In the transmission processing apparatus, after receiving the notification message, the first target device directly detects whether the second predetermined operation occurs without displaying the notification information.

In the transmission processing apparatus, the notification information includes object information of the object.

The object information can include a storage location where the object is stored, such that the first target device can obtain the object by downloading it from the source device based on the storage location.

Alternatively, the object information can include a storage location where the object is stored and object description information of the object, such that the first target device can determine whether to obtain the object or not based on the object description information, and obtain the object by downloading it from the source device based on the storage location when it determines to obtain the object.

Alternatively, the object information can include object description information of the object. The transmission processing apparatus further includes: a third determination module 26 and a second transmission module 27. The third determination module is configured to determine whether a second response message is received, and obtain a third determination result, the second response message being returned by the first target device when the first target device determines to obtain the object based on the object description information after receiving the notification message. The second transmission module 27 is configured to transmit the object data to the first target device via a communication channel to the first target device when the third determination result indicates that the second response message is received.

When the first operation applied to each of a plurality of objects by the source device is the first predetermined operation, the message transmission module is configured to transmit respective notification messages sequentially in accordance with the order in which the first operation is applied to the plurality of objects, such that the first target device can obtain the plurality of objects from the source device based on all the notification messages it receives currently.

The above transmission processing apparatus further includes: a fourth determination module 28 and a third transmission module 29. The fourth determination module 28 is configured to determine whether a first response to message is received, and obtain a fourth determination result. The first response message is returned by the first target device for a first notification message after receiving the notification messages. The third transmission module 29 is configured to transmit object data of a first object corresponding to the first notification message to the first target device via a communication channel to the first target device when the fourth determination result indicates that the first response message is received.

Each of the notification messages includes storage location information indicating a location where the object corresponding to that notification message is stored, such that the first target device can obtain the object data of the first object corresponding to the first notification message by downloading it from the source device based on the storage location information corresponding to the first notification message.

The source device includes a touch screen. The first predetermined operation can be a touch operation in which an area surrounded by a number of pointers is gradually reduced.

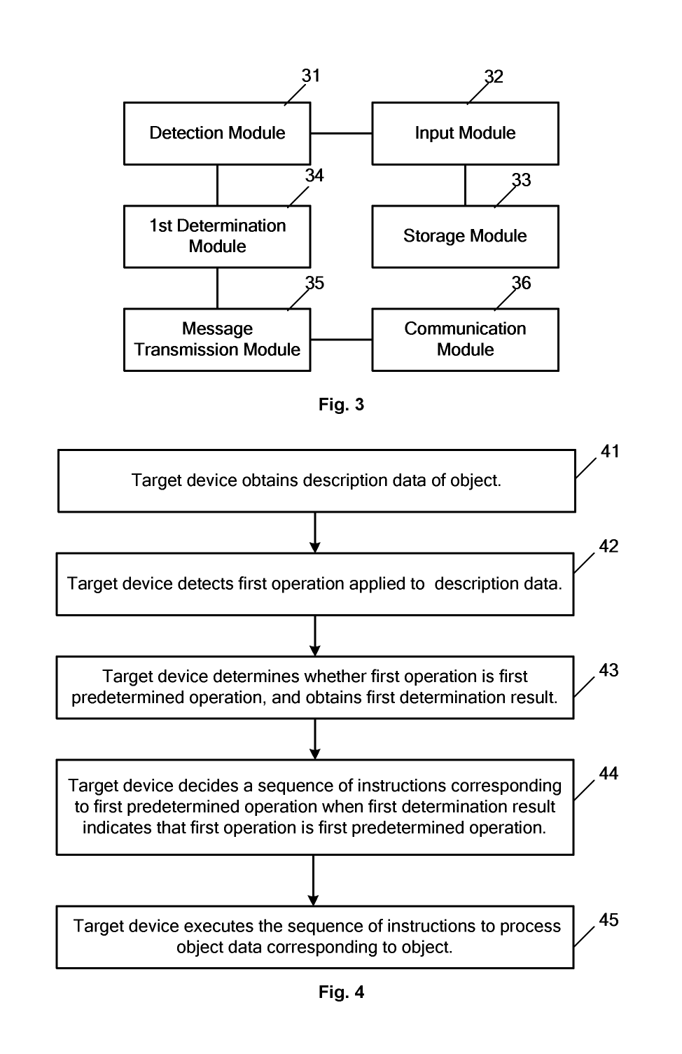

FIG. 3 shows an electronic device according to an embodiment of the present invention. The electronic device includes a storage module 33, an input module 32, a communication module 36, a detection module 31, a first determination module 34, and a message transmission module 35.

The storage module 33 is configured to store object(s). For example, the storage module 33 can be any of various built-in or external hard drives or flash memories.

The input module 32 is configured to receive an input operation from a user. For example, the input module 32 can be a keyboard, a mouse or a touch sensitive device.

The communication module 36 is configured to communicate with other electronic device(s). For example, the communication module 36 can be a Bluetooth communication module, an infrared communication module, a wired network adapter or a wireless network adapter.

The detection module 31 is configured to detect a first operation applied via the input module by the user to the object stored in the storage module.

The first determination module 34 is configured to determine whether the first operation is a first predetermined operation, and obtain a first determination result.

The message transmission module 35 is configured to transmit a notification message to a first target device via the communication module when the first determination result indicates that the first operation is the first predetermined operation, such that the first target device can obtain object data of the object from the source device based on the notification message.

In the transmission processing method, apparatus and the electronic device according to the embodiments of the present invention, the target device can obtain a description data and decide the subsequent processes depending on the operation applied to the description data. In this way, the flexibility of inter-device interaction can be improved.

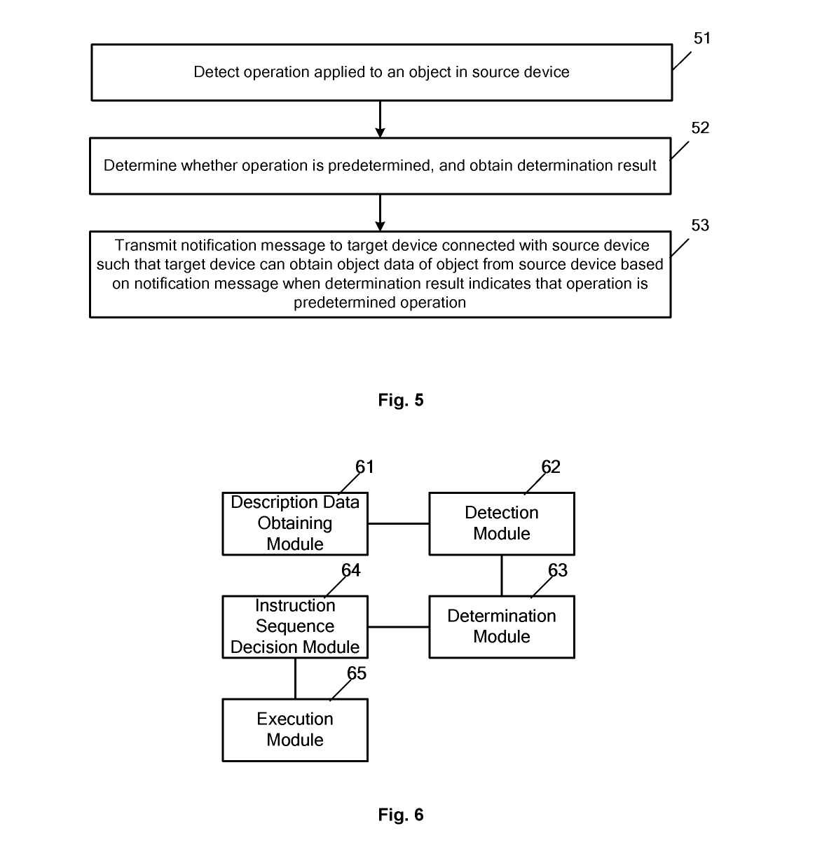

FIG. 4 shows a transmission processing method according to an embodiment of the present invention. The method includes the following steps.

At step 41, a target device obtains description data of an object. The object is stored in a source device different from the target device.

At step 42, the target device detects a first operation applied to the description data.

At step 43, the target device determines whether the first operation is a first predetermined operation, and obtains a first determination result.

At step 44, the target device decides a sequence of instructions corresponding to the first predetermined operation when the first determination result indicates that the first operation is the first predetermined operation.

At step 45, the target device executes the sequence of instructions to process object data corresponding to the object.

In an exemplary embodiment of the present invention, the object can be a folder, a file or an icon stored in the source device. That is, it can be any data carrier that can be selected by a user operation.

In an exemplary embodiment of the present invention, the description data is different from the object data of the object, and is simply data for describing the object.

For example, for any object, the description data can be data for describing the size, type and/or name of the object.

For an electronic book, the description data can describe the name, author and/or format (e.g., TXT, EXE, HTML or PDF) of the electronic book.

For an image object, the description data can describe the size and/or image preview data of the image.

The above examples of description data of the object are illustrative. The description data is used to describe the object to the user. Its information content and form may vary depending on actual requirements, of which further details will be omitted.

According to the embodiments of the present invention, a predetermined operation is predefined and a sequence of instructions corresponding to the predetermined operation is set. When it is detected that the operation applied by the user to the description data is the first predetermined operation, the target device is controlled to execute the sequence of instructions to process the object data corresponding to the object. The user can decide the subsequent processes depending on the description information. In this way, the flexibility of inter-device interaction can be improved.

According to the embodiments of the present invention, there are various situations in which the target device executes the sequence of instructions to process the object data corresponding to the object. Examples of such situations will be described below.

Situation 1

In this situation, the sequence of instructions includes a first sequence of instructions. The target device executes the sequence of instructions to process an object data corresponding to the object by executing the first sequence of instructions to interact with the source device for obtaining the object data of the object, or refuse to obtain the object data of the object from the object.

In the example given below, an e-book is to be transmitted to an electronic device having a touch screen.

It is assumed that the following correspondence is defined: a slide to the right represents a sequence of instructions to refuse to obtain the object; and a slide to the left represents a sequence of instructions to obtain the object.

It is assumed that the object is an e-book named “Tian Long Ba Bu”. After obtaining the description data of the object, the target device presents the description data to the user as follows:

Name of book: Tian Long Ba Bu

Author: JIN Yong

Format: PDF

Then the user can decide whether to obtain this book based on the above description information. For example, if the target electronic device does not support the PDF file format, the user can perform an operation, e.g., by controlling a pointer to slide to the right on the touch screen of the device, so as to execute the instruction to refuse the object and terminate the transmission.

It is assumed that the object is an e-book named “Tian Long Ba Bu”. After obtaining the description data of the object, the target device presents the description data to the user as follows:

Name of book: Tian Long Ba Bu

Author: JIN Yong

Format: TXT

Then the user can decide to obtain this book based on the above description information, e.g., by controlling a pointer to slide to the left on the touch screen of the device, so as to execute the instruction to obtain the object. The process for obtaining the object will be detailed later.

Situation 2

In this situation, the sequence of instructions includes a first sequence of instructions, and a second sequence of instructions. The target device executes the sequence of instructions to process an object data corresponding to the object by executing the first sequence of instructions to obtain from the source device the object data corresponding to the object, and executing the second sequence of instructions to edit the object data.

In the example given below, an image file is to be transmitted to an electronic device having a touch screen.

It is assumed that the following correspondence is defined: a slide to the right represents the sequence of instructions to obtain the object and set it as desktop background; and a slide to the left represents the sequence of instructions to obtain the object and scale it up by 150% for displaying.

It is assumed that the object is a photo X. After a thumbnail of the object X is obtained, it is presented to the user. Then the user can decide whether to obtain this photo based on its thumbnail. The user can also decide the subsequent processes after obtaining the photo. If the user controls a pointer to slide to the right on the touch screen of the device, a first sequence of instructions for obtaining the object will be executed to obtain the object data of the object. Subsequently, a second sequence of instructions is executed to set the photo X as the desktop background. If the user controls the pointer to slide to the left on the touch screen of the device, a first sequence of instructions for obtaining the object will be executed to obtain the object data of the object. Subsequently, a second sequence is of instructions is executed to open the photo X and scale it down by 50%.

The above predetermined operations and the sequences of instructions are exemplary only. For example, the instructions may be instructions to compress and store the image, clip and store the image or display the image at a particular location. Further details for the predetermined operations and the sequences of instructions will be omitted here.

Situation 3

In this situation, the sequence of instructions includes a third sequence of instructions. The target device executes the sequence of instructions to process an object data corresponding to the object by executing the third sequence of instructions to transmit a message including a processing action to the source device, such that the source device can process the object data of the object stored in the source device based on the processing action after receiving the message.

The processing action can be any of various actions including compressing, renaming a file, or the like. It can be defined depending on user requirements, and further details thereof will be omitted here.

Situation 4

In this situation, the sequence of instructions includes a third sequence of instructions, and a first sequence of instructions. The target device executes the sequence of instructions to process an object data corresponding to the object by: executing the third sequence of instructions to transmit a message including a processing action to the source device, such that the source device can process the object data of the object stored in the source, device based on the processing action after receiving the message; and executing the first sequence of instructions to interact with the source device for obtaining, the processed object data of the object.

This situation is a combination of the above situations 1 and 3. Each step of this situation has been detailed above in connection with the situations 1 and 3, and will thus be omitted here.

The sequences of instructions executed by the target device and the processes applied to the object data corresponding to the object as described above only illustrate some possibilities. The embodiments of the present invention are not limited to the above exemplary sequences of instructions executed by the target device.

As mentioned above, in an embodiment of the present invention, the subsequent operations can be decided based on the operation on the object data, e.g., direct transmission. However, in an embodiment of the present invention, in many cases the target device may receive object description data of different objects from a number of source devices. In this case, in an embodiment of the present invention, there is a need for a process for determining an object based on the description data.

In an embodiment of the present invention, when there are description data of a plurality of objects on a plurality of target devices, an object to be operated currently is determined from the plurality of objects based on a detected user operation.

There are a number of approaches for making this determination, as explained in the following.

Approach 1

It is assumed that there are preview data of three images. In this case, the user can preview a first one of the images by controlling two pointers to touch the to touch surface. Further, the user can preview another of the images by keeping one of the pointers stationary while sliding the other pointer. When the user determines that the image is his/her desired one, he/she can control the two pointers to move away from the touch surface, so as to execute a corresponding instruction for obtaining the image data.

Approach 2

It is assumed that there are preview data of three images. In this case, the user can preview the first image by controlling a pointer to draw a trajectory of a number “1” on the touch surface. The user can preview the second image by controlling a pointer to draw a trajectory of a number “2” on the touch surface. The user can preview the third image by controlling a pointer to draw a trajectory of a number “3” on the touch surface.

Alternatively, the user can preview the first image by touching the touch surface with one pointer (finger), preview the second image by touching the touch surface with two pointers (fingers), or preview the third image by touching the touch surface with three pointers (fingers).

The object to be previewed can be determined based on features of pointers. For example, the user's fingerprints can be detected by the touch screen. Provided that the user's fingerprints are pre-stored, the first image can be presented for preview when it is detected that the user's index finger touches the touch screen, the second image can be presented for preview when it is detected that the user's middle finger touches the touch screen, or the third image can be presented for preview when it is detected that the user's ring finger touches the touch screen. The user can preview the first and the second images simultaneously by touching the touch screen with his/her index and middle fingers at the same time.

After previewing an image, the user can control a pointer to draw a trajectory of a check, so as to transmit the image, i.e., starting a subsequent process.

It is to be noted that the above approaches for selecting a description data item from a plurality of description data items are merely exemplary. The above gestures and trajectories may be different depending on user requirements.

In an embodiment of the present invention, the description data of the object can be obtained in various ways. Some examples will be given below.

The description data of the object is obtained by the target device from the source device after receiving a notification message, or directly from the notification message.

The notification message is transmitted by the source device to the target device when it detects that a second operation applied to the object is a second predetermined operation such that the target device can obtain object data of the object from the source device based on the notification message.

When a predetermined operation on an object is detected, a notification message is transmitted to the target device connected to the source device, such that the target device can obtain the object data of the object from the source device based on the notification message. In this way, on the source device side, the user needs to perform only one operation for transmission of the object, and thus the user operation can be simplified and the user operation efficiency can be improved.

Further explanation will be given in the following.

As shown in FIG. 5, in a transmission processing method according to an embodiment of the present invention, a process in which a source device transmits a notification message includes the following steps.

At step 51, an operation applied to an object in a source device is detected.

At step 52, it is determined whether the operation is a predetermined operation, and a determination result is obtained.

At step 53, when the determination result indicates that the operation is the predetermined operation, a notification message is transmitted to a target device connected with the source device, such that the target device can obtain an object to data of the object from the source device based on the notification message.

In an exemplary embodiment of the present invention, the object can be a folder, a file or an icon stored in the source device. That is, it can be any data carrier that can be selected by a user operation.

In an exemplary embodiment of the present invention, a predetermined operation is predefined and an instruction corresponding to the predetermined operation is set to be an instruction for transmitting a notification message. When a predetermined operation applied by a user to an object is detected, the instruction corresponding to the predetermined operation can be executed to transmit the notification message to the target device, such that the target device can obtain the object data of the object from the source device based on the notification message. As noted above, the action performed by the target device depends on the operation at the target device side. In this way, the user needs to perform only one operation for transmission of the object, and thus the user operation can be simplified and the user operation efficiency can be improved.

Here, the description data can be obtained by the target device from the source device after receiving a notification message, or directly from the notification message if it is directly carried by the notification message.

In an exemplary embodiment of the present invention, the predetermined operation can be any of various operations. When the source device includes a touch screen, the predetermined operation can be a touch operation that touches a display location of an operation object for a long duration, or a touch operation in which an area surrounded by a number of pointers is gradually reduced.

The present invention is not limited to these specific forms of the predetermined operation. The predetermined operation can also be represented by any of undefined operation gestures.

In an exemplary embodiment of the present invention, the notification message carries notification information that indicates to the target device that the source device has an object to be transmitted to the target device. The notification information is different from the object data of the object. In other words, the notification information enables the target device to obtain the object by taking further actions based on the notification information, but the target device cannot obtain the object by parsing or reconstructing the notification information itself. The target device can obtain the object only by further interacting with the source device.

In an exemplary embodiment of the present invention, a notification message is to be transmitted to the target device. The target device can be determined by using the following approaches.

1. Broadcast

The source device maintains a list recording all the electronic devices that had been connected with the source device. When the predetermined operation applied to the object in the source device is detected, a notification message is transmitted to each of the electronic devices in the list. In this case, only the device(s) currently connected with the source device can receive the notification message.

2. Detection

Upon detecting the predetermined operation applied to the object in the source device, the source device searches for any electronic device connectable with the source device, and determines all the electronic device(s) connectable with the source device as the target device(s). Then, the source device connects with the target device(s) and broadcasts the notification message to the connected target device(s).

3. User Selection

Upon detecting the predetermined operation applied to the object in the source device, the source device searches for any electronic device connectable with the to source device, and notifies the user of all the electronic device(s) connectable with the source device for selection by the user. Then, the source device determines the user-selected electronic device(s) as the target device(s), and connects with the target device(s) for broadcasting the notification message.

The specific approach for determining the target electronic device can be determined depending on specific requirements, of which further details will be omitted here.

The notification message can be implemented in various ways. In the following, various possible implementations of the notification message will be described in detail. The schemes for transmitting the object to the object device when the target device decides to receive the object will also be explained in detail.

<Implementation I>

In this implementation, the notification message can be simply a prompt message indicating to the target device that there are one or more objects obtainable by the target device in the source device. The notification message itself does not contain any information about the object(s). In this case, according to an embodiment of the present invention, the transmission processing method further includes: determining whether a first response message is received, and obtaining a second determination result, the first response message being returned by the target device after receiving the notification message; and transmitting the object data of the object to the target device via a communication channel to the target device when the second determination result indicates that the first response message is received.

In other words, when deciding to receive the object based on the description data, the target device executes a sequence of instructions, such that the target device can return the first response message after receiving the notification message. Then, the target device receives the object data that is returned by the source device via the communication channel upon receiving the response message.

In an exemplary embodiment of the present invention, the first response message is generated and returned to the source device when the target device detects a second predetermined operation after receiving the notification message.

In this implementation, merely simple operations need to be performed on the is source and target devices to enable transmission of the object between the devices. Therefore, the user operation can be simplified and the user operation efficiency can be improved.

An application example will be given below for illustrating the above implementation.

It is assumed that four users, A, B, C and D, are discussing a project in a conference room. The users each have a portable touch-controlled PAD, and these PADs are connected with each other. Now, User A has a project schedule to be transmitted to User B, User C and User D for discussion.

In this case, User A selects the project schedule file and performs a grasp gesture on the file at its display location, i.e., User A's fingers first cover the file and then converge gradually.

When User A is performing the above operation, the electronic device can detect the grasp gesture and determine that it is the predetermined operation. At this time, the PAD of User A will transmit a notification message to the PAD of each of User B, User C and User D, notifying that there is an object to be transmitted on the PAD of User A.

After receiving the description data of the project schedule, User B and User C determine that they do not have the project schedule, and thus perform a predetermined operation on their respective PADs. The PAD of each of User B and User C detects the operation performed by that user, which indicates that the user wants to receive this object. Thus, the PAD of each of User B and User C returns a response message to the PAD of User A. Upon receiving the response messages, the PAD of User A will transmit, via the communication channels to the PADs of User B and User C, the object data of the object to the target devices.

On the other hand, after receiving the description data of the project schedule, User D determines that he/she has had this project schedule, and thus performs another predetermined operation on his/her PAD. The PAD detects the operation performed by User D, which indicates that User D refuses to receive this object. Therefore, the transmission is terminated.

The techniques for establishing a communication channel and transmitting data via the established channel are well known to those skilled in the art and the details thereof will be omitted here.

With the above implementation, the embodiments of the present invention allow the users to determine the subsequent processes depending on their respective demands. In this way, the flexibility in data exchange can be improved.

<Implementation II>

In this implementation, the notification message includes a storage location where the object is stored.

The object information includes a storage location where the object is stored, such that the target device can obtain the object by downloading it from the source device based on the storage location.

Unlike the Implementation I, in this example, the object data of the object is not transmitted by the source device, and is downloaded by the target device. Since the notification message carries the storage location of the object, the target device can directly obtain the object by downloading it from the source device based on the storage location. The target device needs to obtain the description data, determines whether to obtain the object or not based on the description data, and then performs the subsequent operations if it determines to the obtain the object.

In an exemplary embodiment of the present invention, in many cases the target device may receive notification messages from a plurality of source devices. In this case, a queue of notification messages can be provided at the target device, corresponding to a plurality of description data. The user can switch between the plurality of description data using a slide gesture and determine the process corresponding to each object.

In an embodiment of the present invention, the object can be copied and transmitted from the source device to the target device, or can be directly cut and transmitted from the source device to the target device, in accordance with corresponding gestures. Here a gesture means both an instruction for transmission and an instruction on whether to maintain the object locally. Further details for the gestures will be omitted here.

An abort mechanism can be provided in the method according to an embodiment of the present invention. When another predetermined operation is detected after the first predetermined operation, indicating that the source device decides to terminate the ongoing transmission, another notification message can be transmitted to the target electronic device for notifying the termination of the transmission.

All the gestures (or predetermined operations) according to the embodiments of the present invention can be defined depending on the user's requirements, as long as they do not conflict with other defined operations.

FIG. 6 shows a transmission processing apparatus according to an embodiment of the present invention. The apparatus includes a description data obtaining module 61, a detection module 62, a determination module 63, an instruction sequence decision module 64, and an execution module 65.

The description data obtaining module 61 is configured to obtain description data of an object. The object is stored in a source device.

The detection module 62 is configured to detect a first operation applied to the description data.

The determination module 63 is configured to determine whether the first operation is a first predetermined operation, and obtain a first determination result.

The instruction sequence decision module 64 is configured to decide a sequence of instructions corresponding to the first predetermined operation when the first determination result indicates that the first operation is the first predetermined operation.

The execution module 65 is configured to execute the sequence of instructions to process object data corresponding to the object.

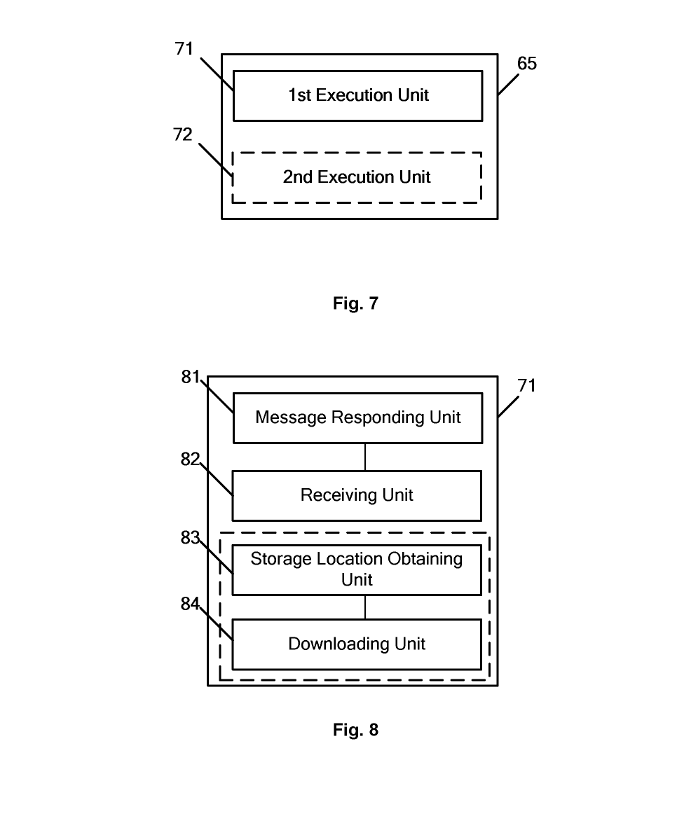

In the transmission processing apparatus, the sequence of instructions includes a first sequence of instructions. As shown in FIG. 7, the execution module includes a first execution unit 71 configured to execute the first sequence of instructions to interact with the source device for obtaining the object data of the object.

In the transmission processing apparatus, the sequence of instructions includes a first sequence of instructions and a second sequence of instructions. The execution module includes: a first execution unit 71 configured to execute the first sequence of instructions to obtain from the source device the object data corresponding to the object; and a second execution unit 72 configured to execute the second sequence of instructions to edit the object data.

The source device includes a detection module 21, a first determination module 22 and a message transmission module 23.

The detection module 21 detects a first operation applied to an object in a source device.

The first determination module 22 determines whether the first operation is a first predetermined operation, and obtain a first determination result.

The message transmission module 23 transmits a notification message to a first target device connected with the source device when the first determination result indicates that the first operation is the first predetermined operation, such that the first target device can obtain object data of the object from the source device based on the notification message.

Therefore, in the above transmission processing apparatus, the description data of the object is obtained by the target device from the source device after receiving a notification message or directly from the notification message. The notification message is transmitted by the source device to the target device when it detects that a second operation applied to the object is a second predetermined operation, such that the target device can obtain object data of the object from the source device based on the notification message.

In the transmission processing apparatus, the notification message contains notification information which is different from the object data of the object, and indicates to the target device that the source device has the object available to be transmitted to the target device.

The source device further includes a second determination module 24 and a first transmission module 25. The second determination module 24 is configured to determine whether a first response message is received, and obtain a second determination result. The first response message is returned by the first target device after receiving the notification message. The first transmission module 25 is configured to transmit the object data of the object to the first target device via a communication channel to the first target device when the second determination result indicates that the first response message is received.

In the transmission processing apparatus, as shown in FIG. 8, the first execution unit 71 includes: a message responding unit 81 configured to return a first response message after receiving the notification message; and a receiving unit 82 configured to receive the object data returned by the source device via a communication channel upon receiving the response message.

In the transmission processing apparatus, the notification message has recorded therein a storage location where the object is stored. The first execution unit includes: a storage location obtaining unit 83 configured to obtain the storage location from the received notification message; and a downloading unit 84 configured to obtain the object data by downloading it from the source device based on the storage location.

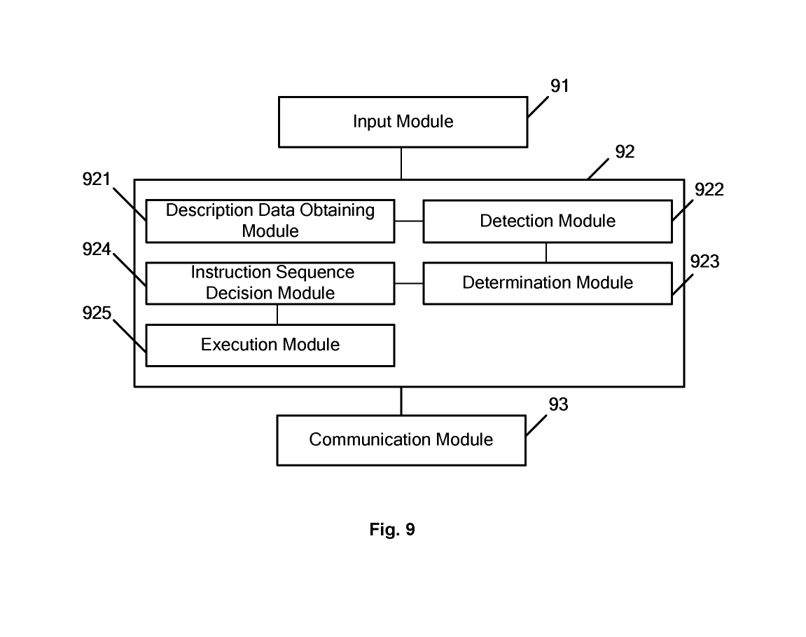

As shown in FIG. 9, an electronic device according to an embodiment of the is present invention includes an input module 91, a communication module 93, and a processor 92.

The input module 91 is configured to receive an input operation from a user. For example, the input module 91 can be a keyboard, a mouse or a touch sensitive device.

The communication module 93 is configured to communicate with other electronic device(s). For example, the communication module 93 can be a Bluetooth communication module, an infrared communication module, a wired network adapter or a wireless network adapter.

The processor 92 is configured to: obtain description data of an object stored in a source device via the communication module; detect a first operation applied by the user to the description data via the input module; determine whether the first operation is a first predetermined operation, and obtain a first determination result; decide a sequence of instructions corresponding to the first predetermined operation when the first determination result indicates that the first operation is the first predetermined operation; and execute the sequence of instructions to process an object data corresponding to the object.

In particular, the processor includes: a description data obtaining module 921 configured to obtain the description data; a detection module 922 configured to detect the first operation applied to the description data; a determination module 923 configured to determine whether the first operation is the first predetermined operation, and obtain the first determination result; an instruction sequence decision module 924 configured to decide the sequence of instructions corresponding to the first predetermined operation when the first determination result indicates that the first operation is the first predetermined operation; and an execution module 925 configured to execute the sequence of instructions to process the object data corresponding to the object.

In the embodiments of the present invention, the modules can be implemented in software to be executed by any of various processors. For example, a representative executable code module may be one or more physical or logic blocks including computer instructions. For example, it can be constructed as an object, process or function. Nevertheless, representative modules of executable codes are not necessarily co-located physically, but can instead include different instructions stored at different locations. When these instructions are logically combined, they constitute a module and implement the specified function of the module.

In practice, an executable code module can be one or more instructions that can even be distributed over a number of different code segments, over different programs or across a number of storage elements. Likewise, operation data can be identified within a module and can be implemented in any appropriate form and organized in any appropriate type of data structure. The operation data can be collected as a single data set or distributed at different locations (i.e., included in different storage elements) and may at least partially exist as electronic signals on a system or a network.

When a module can be implemented in software, it can be implemented in software due to the limited capability in current hardware processes. If the cost is not a consideration factor, those skilled in the art can build hardware circuits to implement the corresponding functions. The hardware circuits may include conventional Very Large Scale Integrated (VLSI) circuits or gate arrays and existing semi-conductor elements such as logic chips and transistors or other discrete elements. The modules can also be implemented by programmable hardware devices such as field programmable gate arrays, programmable array logics or programmable logic devices.

While the preferred embodiments of the present invention have been described above, the present invention is not limited to these embodiments. Any modifications, equivalents or enhancements that are made without departing from the spirit and principle of the present invention are to be encompassed by the scope of the present invention.

1. A transmission processing method, comprising:
detecting a first operation applied to an object in a source device;
determining whether the first operation is a first predetermined operation, and obtaining a first determination result; and
transmitting a notification message to a first target device connected with the source device when the first determination result indicates that the first operation is the first predetermined operation, such that the first target device can obtain object data of the object from the source device based on the notification message.

2. The transmission processing method of claim 1, wherein the notification message contains notification information which is different from the object data of the object and indicates to the first target device that the source device has an object available to be transmitted to the first target device, and the transmission processing method further comprises:
determining whether a first response message returned by the first target device after receiving the notification message is received, and obtaining a second determination result; and
transmitting the object data of the object to the first target device via a communication channel to the first target device when the second determination result indicates that the first response message is received.

3. The transmission processing method of claim 2, wherein the first response message is generated and returned to the source device when the first target device detects a second predetermined operation after receiving the notification message.

4. The transmission processing method of claim 3, wherein, after receiving the notification message, the first target device directly detects whether the second predetermined operation occurs without displaying the notification information.

5. The transmission processing method of claim 2, wherein the notification information comprises a storage location where the object is stored, such that the first target device can obtain the object by downloading it from the source device based on the storage location.

6. The transmission processing method of claim 2, wherein the notification information comprises a storage location where the object is stored and object description information of the object, such that the first target device can determine whether to obtain the object or not based on the object description information, and obtain the object by downloading it from the source device based on the storage location when it determines to obtain the object.

7. The transmission processing method of claim 2, wherein the notification information comprises object description information of the object, and the transmission processing method further comprises:
determining whether a second response message is received, and obtaining a third determination result, the second response message being returned by the first target device when the first target device determines to obtain the object based on the object description information after receiving the notification message; and
transmitting the object data to the first target device via a communication channel to the first target device when the third determination result indicates that the second response message is received.

8. The transmission processing method of claim 2, wherein, when the first operation applied to each of a plurality of objects by the source device is the first predetermined operation, the step of transmitting a notification message to a first target device connected with the source device comprises:
transmitting respective notification messages sequentially in accordance with the order in which the first operation is applied to the plurality of objects, such that the first target device can obtain the plurality of objects from the source device based on all the notification messages it receives currently.

9. A transmission processing apparatus for use in an electronic device, comprising:
a detection module configured to detect a first operation applied to an object in a source device;
a first determination module configured to determine whether the first operation is a first predetermined operation, and obtain a first determination result; and
a message transmission module configured to transmit a notification message to a first target device connected with the source device when the first determination result indicates that the first operation is the first predetermined operation, such that the first target device can obtain an object data of the object from the source device based on the notification message.

10. The transmission processing apparatus of claim 9, wherein the notification message contains notification information which is different from the object data of the object and indicates to the first target device that the source device has an object available to be transmitted to the first target device, and the transmission processing apparatus further comprises:
a second determination module configured to determine whether a first response message returned by the first target device after receiving the notification message is received, and obtain a second determination result; and
a first transmission module configured to transmit the object data of the object to the first target device via a communication channel to the first target device when the second determination result indicates that the first response message is received.

11. The transmission processing apparatus of claim 10, wherein the first response message is generated and returned to the source device when the first target device detects a second predetermined operation after receiving the notification message.

12. The transmission processing apparatus of claim 11, wherein, after receiving the notification message, the first target device directly detects whether the second predetermined operation occurs without displaying the notification information.

13. The transmission processing apparatus of claim 10, wherein the notification information comprises a storage location where the object is stored, such that the first target device can obtain the object by downloading it from the source device based on the storage location.

14. The transmission processing apparatus of claim 10, wherein the notification information comprises a storage location where the object is stored and object description information of the object, such that the first target device can determine whether to obtain the object or not based on the object description information, and obtain the object by downloading it from the source device based on the storage location when it determines to obtain the object.

15. The transmission processing apparatus of claim 10, wherein the notification information comprises object description information of the object, and the transmission processing apparatus further comprises:
a third determination module configured to determine whether a second response message is received, and obtain a third determination result, the second response message being returned by the first target device when the first target device determines to obtain the object based on the object description information after receiving the notification message; and
a second transmission module configured to transmit the object data to the first target device via a communication channel to the first target device when the third determination result indicates that the second response message is received.

16. The transmission processing apparatus of claim 10, wherein, when the first operation applied to each of a plurality of objects by the source device is the first predetermined operation, the message transmission module is configured to transmit respective notification messages sequentially in accordance with the order in which the first operation is applied to the plurality of objects, such that the first target device can obtain the plurality of objects from the source device based on all the notification messages it receives currently.

17-24. (canceled)

25. A transmission processing apparatus for use in an electronic device, comprising:
a description data obtaining module configured to obtain description data of an object stored in a source device different from a target device;
a detection module configured to detect a first operation applied to the description data;
a determination module configured to determine whether the first operation is a first predetermined operation, and obtain a first determination result;
an instruction sequence decision module configured to decide a sequence of instructions corresponding to the first predetermined operation when the first determination result indicates that the first operation is the first predetermined operation; and
an execution module configured to execute the sequence of instructions to process object data corresponding to the object.

26. The transmission processing apparatus of claim 25, wherein the sequence of instructions comprises a first sequence of instructions, and the execution module comprises:
a first execution unit configured to execute the first sequence of instructions to interact with the source device for obtaining the object data of the object.

27. The transmission processing apparatus of claim 25, wherein the sequence of instructions comprises a first sequence of instructions and a second sequence of instructions, and the execution module comprises:
a first execution unit configured to execute the first sequence of instructions to obtain from the source device the object data corresponding to the object; and
a second execution unit configured to execute the second sequence of instructions to edit the object data.

28. The transmission processing apparatus of claim 26, wherein the description data of the object is obtained by the target device from the source device after receiving a notification message or directly from the notification message, the notification message being transmitted by the source device to the target device when it detects that a second operation applied to the object is a second predetermined operation, such that the target device can obtain object data of the object from the source device based on the notification message.

29. The transmission processing apparatus of claim 28, wherein the notification message contains notification information which is different from the object data of the object and indicates to the target device that the source device has the object available to be transmitted to the target device.

30. The transmission processing apparatus of claim 28, wherein the first execution unit comprises:
a message responding unit configured to return a first response message after receiving the notification message; and
a receiving unit configured to receive the object data returned by the source device via a communication channel upon receiving the response message.

31. The transmission processing apparatus of claim 28, wherein the notification message has recorded therein a storage location where the object is stored, and the first execution unit comprises:
a storage location obtaining unit configured to obtain the storage location from the received notification message; and
a downloading unit configured to obtain the object data by downloading it from the source device based on the storage location.

32-33. (canceled)
